(19) United States
(12) Patent Application Publication
(10) Pub. No.: US 2022/0341832 A1
(43) Pub. Date: Oct. 27, 2022

(54) Thermal fatigue crack generator for large pipe

(71) Applicant: HOJIN INDUSTRIAL.CO.,LTD., Seoul (KR)

(72) Inventors: HYEONG GEUN AHN, Seoul (KR); JAE SEONG KIM, Yongin-si (KP)

(21) Appl. No.: 17/427,233

(22) PCT Filed: Jan. 10, 2020
(86) PCT No.: PCT/KR2020/000503

§ 371 Date: Jul. 30, 2021

(30) Foreign Application Priority Data
Dec. 31, 2019 (KR) 10-2019-0179148

(51) Int. Cl. G01N 3/60; G01N 3/18; G01N 25/72

(52) U.S. Cl. CPC G01N 3/60; G01N 3/18; G01N 25/72; G01N 2203/0073

(57) ABSTRACT

The present invention discloses a thermal fatigue crack generator for a large pipe. According to the present invention, the thermal fatigue crack generator for a large pipe precisely manages and controls the heating and cooling conditions for the large size test pipes having a diameter of 250 to 610 mm to significantly improve the reliability of the accuracy and a reproducibility of the thermal fatigue cycle so that a useful advantage is expected to ensure the reliability and the effectiveness of the skill verification of the non-destructive testing.

### TECHNICAL FIELD

The present invention relates to a thermal fatigue crack generator for a large pipe which may form a thermal fatigue crack for a large pipe under the condition same as an actual environment, and more particularly, to a thermal fatigue crack generator for a large pipe which improves usability by enabling inspection of a large pipe having various sizes used for nuclear power plant structures, ensures the reliability of inspection by precisely controlling and managing a thermal fatigue cycle which repeats heating and cooling, and accurately predicts and diagnoses the risk of actual nuclear power plant facilities.

### BACKGROUND ART

According to the international automic energy agency (IAEA), currently 43 nuclear power plants are in operation around the world and more than 80% of them have been in operation for more than 20 years and diagnosed that there is a concern about the safety due to deterioration. Further, in Korea, nuclear power plants, which have been consistently in charge of a significant portion of domestic power since Kori nuclear power plant No. 1 began commercial operation in 1978, are also reaching their design lifetime limits as indicated in the following Table 1.

TABLE 1
Remaining service lifetime of Korea nuclear power plant

| | Commercial | Design | | Remaining |
|---|---|---|---|---|
| Name of | operation | lifetime | Design | service |
| power | began | will expire in | lifetime | lifetime |
| plant | in (year) | (year) | (years) | (years) |
| Kori #2 | 1983 | 2023 | 40 | 7 |
| Kori #3 | 1985 | 2024 | 40 | 8 |
| Kori #4 | 1986 | 2025 | 40 | 9 |
| Yeonggwang #1 | 1986 | 2025 | 40 | 9 |
| Yeonggwang #2 | 1987 | 2026 | 40 | 10 |
| Uljin #1 | 1988 | 2027 | 40 | 11 |
| Uljin #2 | 1989 | 2028 | 40 | 12 |
| Wolsong #2 | 1997 | 2026 | 30 | 10 |
| Wolsong #3 | 1998 | 2027 | 30 | 11 |
| Wolsong #4 | 1999 | 2029 | 30 | 13 |

Cases of damages or internal cracks such as thermal fatigue cracks and stress corrosion cracks (SCC) which may cause problems in the safety of nuclear power plants in operation at domestic and overseas nuclear power plants are continuously being reported in accordance with the aging of the nuclear power plants.

The thermal fatigue cracks and the stress corrosion cracks which cause major damages in the nuclear power plant structures are mainly caused by an operating condition of the nuclear power plants. The thermal fatigue crack is known to be caused by thermal stress gradients due to thermal stratification in the pressurizer surge line, the RCS safety relief line, and the emergency core cooling system.

That is, the cracking phenomenon generated in the nuclear power plant structure is generated in a steam generator, a reactor pressure vessel, a nozzle, and a pressurizer due to a high temperature and high pressure, a corrosive environment, and a residual stress so that there is a risk of radiation leakage. Therefore, it is necessary to check the damages and the cracks which are consistently generated in accordance with the aging of the nuclear power plant structures and for this reason, in-service inspection (ISI) is periodically performed. Most of the in-service inspection conducts preventive maintenance for a safety accident which may occur, by non-destructive testing method (NDT). Accordingly, in order to ensure the safety of the nuclear power plants and the reliability of the NDT technique, it is very important to ensure a technique which manufactures a season crack similar to an actual defect which is generated in the nuclear power plant in operation.

To this end, according to the present invention which configures an experiment device which may simulate a thermal fatigue crack generation condition in an actual nuclear power plant structure, the reliability and the safety of the nuclear power plant may be improved and an advanced precise diagnostic technique which may diagnose the defect during the operation may be obtained. That is, when a source technology of producing and precisely diagnosing an actual simulated thermal fatigue crack in a piping material which is actually used in the nuclear power plants is ensured, it is possible to develop the in-service inspection technique and be utilized as data for safety regulations and maintenance standards for the nuclear power plant structures.

In Korea, in order to overcome the limitation of precise detection capability and the reliability, a skill verification system of the United States, which has been conducting skill verification of non-destructive testing technicians since 2000, has been introduced and applied since 2005. However, the PDI test specimen (actual cracking test specimen) is not directly used to correct the equipment for precise diagnose of the nuclear power plant structures, but is used only to verity the skill of the non-destructive testing technicians. Further, due to the lack of the technique of producing an actual crack, most of the PDI test specimens which have been used in Korea are being imported from foreign countries.

Further, these test specimen are not directly produced in the pipe in an environment similar to the season crack, but mostly implanted in a piping material or a welding portion after being produced by means of a general fatigue test, rather than the thermal fatigue crack by the heat, by means of wire cutting and CT specimen using electric discharge. Therefore, the test specimen which are produced by the normal fatigue crack forming method of the related art are not generated in the piping material of the nuclear power plants in operation or the facility of the device industry, but are manufactured as a simulation specimen. Therefore, as the difference occurs in many parts from the actual crack, there was a disadvantage in that the effectiveness of the skill verification of the non-destructive test is not reliability guaranteed.

Further, in many cases, it is difficult to promptly utilize the test pieces when necessary and it is difficult to satisfy the demand when a large number of test pieces is necessary for skill verification and training in the NDT industry. In order to solve the above-mentioned problems, as a related art, Korean Registered Patent No. 10-0801404 entitled “Apparatus for forming a thermal fatigue crack” has been proposed and in claim 1, “an apparatus for forming a thermal fatigue crack including a heating unit having a conducive member attached around the outer circumferential surface of a pipe specimen and an induction heating coil disposed adjacent to the conductive member; a cooling unit having a cooling water pump and a cooling water hose for forcibly supplying cooling water to the inner diameter surface of the pipe specimen from a cooling water storage source, and a control unit for controlling an operation of the heating unit and the cooling unit” is disclosed.

As another related art, the inventor of this application has proposed Korean Registered Patent No. 10-0920102 (Sep. 25, 2009) entitled “Apparatus for forming longitudinal thermal fatigue cracks” and in claim 1, “an apparatus for forming a longitudinal thermal cracks, including a heating unit having an induction heating coil disposed adjacent to an outer circumference of a test piece made of pipe of which a notch is formed, a cooling unit having a cooling water pump and a cooling water hose which forcibly inject cooling water from a cooling water storage source into an inner circumference of the test piece made of pipe, and a control unit controlling an operation of the heating unit and the cooling unit, in which as a tubular member which is in close contact with the outer circumference of the test piece made of pipe to enclose the outer circumference so as to control a magnitude of the stress in the circumferential direction, a cooling block which has a slit for controlling crack positions formed in a longitudinal direction and has a cooling water line which is piped to a cooler controlled by the cooling temperature controller so that a cooling source configured by a cooling water or cooling gas is introduced to be circulate, and is selectively supplied with a cooling source to repeatedly cool the test piece made of pipe heated by the heating unit to adjust the temperature gradient” has been proposed.

As another related art, the inventor of this application has proposed Korean Registered Patent No. 10-0909118 entitled “apparatus for forming stress corrosion crack” and in claim 1, “an apparatus for forming a stress corrosion crack including a heating unit which includes a conductive member provided on one outer circumference of a tubular test piece in a circumferential direction and a heating coil disposed adjacent to the conductive member to generate a steam pressure in the pipe, an end holding unit for closing both open ends so that steam pressure generated in the tubular test piece does not leak, and a control unit for controlling the heating unit and the end holding unit in which the end holding unit includes an upper plate and a lower plate for closing both ends of the tubular test piece and a tension bar provided as a hydraulic or pneumatic cylinder using hydraulic or pneumatic pressure as an operation pressure by adjusting a distance between the upper plate and the lower plate or an actuator which moves in and out a rod by supplying a power” is disclosed.

However, even though the a thermal fatigue crack generator for a large pipe according to the related art repeatedly locally heats and cools the tubular test piece to generate thermal fatigue, it cannot precisely and uniformly control a thermal fatigue cycle. Therefore, there is a limit to increasing the reliability of the inspection so that as a result, there is a serious problem in that the risk for the actual nuclear power plant facility cannot be precisely predicted or diagnosed.

Further, it is difficult to test the pipe specimens with various sizes so that an exclusive device according to the size of the pipe specimen needs to be manufactured, which may degrade the economic efficiency. Further, a plurality of devices needs to be operated in accordance with the size of the pipe specimen so that it is inefficient in terms of the space for installing and operating the device and the maintenance thereof. In order to solve this problem, this applicant proposed Korean Registered Patent No. 10-2038781 entitled “Flow-controlled thermal fatigue crack generation apparatus” and in claim 1, a flow-controlled thermal fatigue crack generation apparatus configured by a frame unit which is in close contact with both surfaces of a penetrated pipe specimen to be supplied with a cooling water from the outside and guide the cooling water into the pipe specimen; a heating unit which is disposed adjacent to one outer surface of the pipe specimen to locally heat; a cooling unit including a cooling water pump which forcibly supplies the cooling water into the pipe specimen to cool the pipe specimen, a flow detector which detects an internal flow of the pipe specimen, and a flow control valve which is installed on a cooling water line connecting the cooling water pump and the pipe specimen to control the flow; a control unit including a thermal fatigue cycle control unit including a heating control module which detects a heating temperature and a heat time of the heating unit to calculate a flow and a water passing time of the cooling water which passes through the pipe specimen to apply a control signal to the heating unit and the cooling unit to control a heating temperature and an on/off operation of the heating unit and a heating position detecting module which detects a position of a heating point of the locally heated pipe specimen; and a thermal stress control unit which receives heating point position information of the pipe specimen from the heating position detecting module to calculate a position of the cooling point for setting a thermal stress generation section based thereon and applies a control signal to the flow control valve to maintain a level of the cooling water in the calculated position of the cooling point” is disclosed.

However, the flow-controlled thermal fatigue crack generation apparatus proposed by this applicant easily heats and cools a small size pipe specimen having a relatively small diameter of 250 mm to precisely manage the thermal fatigue cycle of repeating heating and cooling. However, in the case of the large size pipe specimen having a diameter of 250 mm to 610 mm, it takes a long time to heat and cool so that it is difficult to precisely manage the thermal fatigue cycle. As a result, it is difficult to control the size for the thermal fatigue crack to be manufactured so that there is not only a limit to improving the test reliability of non-destructive test technicians, but also a problem in that the safety evaluation for the actual nuclear power plants cannot be accurately predicted and diagnosed.

### DISCLOSURE

### Technical Problem

The present invention has been made to solve the problems of the related art as described above and an object of the present invention is to provide a thermal fatigue crack generator for a large pipe which enables the inspection for various large test pipes having a diameter of 250 mm to 610 mm used for the nuclear power plant structures to increase an operation efficiency of standardization of the equipment and consistently and precisely control the thermal fatigue cycle which repeats heating and cooling to improve the reliability of the inspection.

Specifically, the heating unit is located below the pipe specimen so that the difference between the heating temperature in accordance with a setting temperature and the internal surface temperature of the pipe specimen at the time of cooling by the cooling water ejection control unit which is configured in the pipe specimen may be most significantly and precisely controlled and managed so that the reliability for the thermal stress reproducibility formed by the thermal fatigue cycle which repeats heating and cooling may be significantly improved. Therefore, an advantage is expected to ensure the reliability and the effectiveness of the actual crack reference test piece for skill verification of the non-destructive test with respect to a large pipe having a diameter of 250 mm or larger. That is, an object of the present invention is to provide a thermal fatigue crack generator for a large pipe which ensures the regular reproducibility for the thermal stress and enables the prediction and diagnosis with a high reliability by quickly and precisely managing and controlling the flow and the discharge of the cooling water which flows in the pipe specimen in the related art.

### Technical Solution

In order to achieve the above-described object, according to an aspect of the present invention, a thermal fatigue crack generator for a large pipe includes: a frame unit which fixedly supports a pipe specimen having a semicircular shape cross-section obtained by cutting a cylindrical pipe having a diameter of 250 mm to 610 mm in a longitudinal direction; a heating unit which is disposed adjacent to an outer surface of a lower portion of the pipe specimen to locally heat the pipe specimen; a cooling unit which includes a cooling water pump which forcibly supplies cooling water into the pipe specimen; a discharge unit which is provided at one side of the pipe specimen to discharge the cooling water therein to the outside; and a cooling water ejection control unit which generates a thermal stress formed by a thermal fatigue cycle by repeatedly heating and cooling the pipe specimen by applying a control signal to the heating unit and the cooling unit and senses the presence of the heating operation of the heating unit to control the heating unit to perform a heating operation after discharging the cooling water in the pipe specimen by applying a control signal to the discharge unit before the heating operation.

As a desirable feature of the present invention, the frame unit includes: a fixed flange which is in close contact with any one of both surfaces of the pipe specimen in a longitudinal direction to be closed; a movable flange which is connected to the fixed flange by a plurality of guide posts to slide back and forth and is in close contact with the other surface of the pipe specimen to be closed and is connected with a cooling water supply line through which the cooling water is supplied from the outside at one side; an extension/contraction sensing unit which senses an extension/contraction rate by the heating and cooling operation acting on the pipe specimen fixedly supported between the fixed flange and the movable flange; a thermal expansion compensating unit which is applied with a sensing signal from the extension/contraction sensing unit to displace the fixed flange and the movable flange in a longitudinal direction.

As another desirable feature of the present invention, the heating unit includes: a heater which is configured by any one of an induction heating coil which is applied with a high frequency current to form a magnetic field to induce the heating or a direct heating coil having a heating line which is supplied with a power to heat; a heating temperature sensor which measures a heating temperature of the heater; and a heating timer which measures a heating time of the heater.

As another desirable feature of the present invention, the cooling unit includes: a flow detector which detects a flow of the cooling water in the pipe specimen; a flow control valve which is installed on a cooling water line supplying the cooling water to the cooling water pump and the pipe specimen to control the flow; and a water temperature sensor which measures a temperature of the cooling water supplied to the pipe specimen.

As another desirable feature of the present invention, the discharge unit includes: a discharge pipe line which is connected into the pipe specimen through a lower side thereof; a discharge valve which is installed on the discharge pipe line to selectively open/close a pipe line to discharge the cooling water in the pipe specimen to the outside.

As another desirable feature of the present invention, the cooling water ejection control unit includes: a discharge control unit which applies a control signal for a discharge operation to the discharge unit to eject all the cooling water in the pipe specimen before starting the heating operation of the heating unit in a state in which the cooling water is supplied in the pipe specimen; a heating control unit which is applied with a cooling water discharge completion signal from the discharge control unit to control a heating temperature and an on/off operation of the heating unit; and a heating position detecting unit which detects a position of the heating point of the pipe specimen which is locally heated by the heating unit.

As another desirable feature of the present invention, the extension/contraction sensing unit includes any one of an elastic displacement sensor which measures an elastic displacement in accordance with the extension/contraction of the pipe specimen by connecting the fixed flange and the movable flange and a pressurization sensor which is provided in one or both of the fixed flange and the movable flange in a portion in contact with the pipe specimen to measure a pressure; and a pressurization control unit which is applied with sensing information from the extension/contraction sensing unit to calculate an extension/contraction rate of the pipe specimen and moves back and forth the movable flange with respect to the fixed flange based thereon to output a control signal to control the contact degree with the pipe specimen; and an actuator which is applied with a control signal from the pressurization control unit to be connected to any one of the movable flange and the fixed flange to generate a position displacement to a straight direction by a driving source.

### Advantageous Effects

According to the present invention, the thermal fatigue crack generator for a large pipe precisely manages and controls the heating and cooling conditions for the large size test pipes having a diameter of 250 mm to 610 mm to significantly improve the accuracy and the reliability of a reproducibility of the thermal fatigue cycle so that a useful advantage is expected to ensure the reliability and the effectiveness of the skill verification of the non-destructive testing.

Further, according to the present invention, the extension/contraction rate for the thermal expansion and contraction generated when the large pipe specimen is heated is compensated so that the environment in which the actual pipe is installed is reproduced as it is, to increase the reliability in accordance with the test condition.

Further, according to the present invention, the movable flange moves back and forth with respect to the fixed flange by the actuator so that a solid and stable contact state with both open sides of the pipe specimen having a semicircular arc shape cross-section is maintained. Therefore, not only the negative effect such as cooling water leakage may be prevented in advance, but also the workability and the operation hours in accordance with preparation for the test operation may be improved.

Specifically, large pipe specimens having various sizes may be inspected so that the economic effect and the convenience of maintenance may be increased by the efficient operation of the device.

The characteristics and advantages of the present invention will be clearer through the detailed description referring to the accompanying drawings. Prior to this, terms or words used in the specification and the claims should not be analyzed as a general and dictionary meaning and should be analyzed as a meaning and a concept which conform to the technical spirit of the present invention based on a principle that the inventor can appropriately define a concept of a term in order to describe his/her own invention by the most method.

### DESCRIPTION OF DRAWINGS

FIG. 1 is a perspective view illustrating a state in which a pipe specimen is installed in a thermal fatigue crack generator for a large pipe according to the present invention.

FIG. 2 is a perspective view of a thermal fatigue crack generator for a large pipe illustrated in FIG. 1 as seen from a rear side.

FIG. 3 is a perspective view of a thermal fatigue crack generator for a large pipe illustrated in FIG. 2 as seen from a bottom.

FIGS. 4 and 5 are perspective views for explaining a configuration of a thermal fatigue crack generator for a large pipe according to the present invention.

FIG. 6 is a schematic view for explaining a configuration of an extension/contraction sensing unit and a thermal expansion compensating unit in a thermal fatigue crack generator for a large pipe according to the present invention.

FIG. 7 is a schematic view for explaining a configuration of a cooling unit in a thermal fatigue crack generator for a large pipe according to the present invention.

FIG. 8 is a block diagram for explaining a configuration of a cooling water ejection control unit in a thermal fatigue crack generator for a large pipe according to the present invention.

FIG. 9 is a block diagram for explaining a configuration of a guide unit in a thermal fatigue crack generator for a large pipe according to the present invention.

FIG. 10 is a block diagram for explaining a configuration of a cooling unit in a thermal fatigue crack generator for a large pipe according to the present invention. [Description of Main Reference Numerals of Drawings]

| 1: Thermal fatigue crack generator for large pipe | |
|---|---|
| 10: Frame unit | 11: Fixed flange |
| 12: Guide post | 13: Movable flange |
| 15: Extension/contraction sensing unit | |
| 17a: Pressurization control unit | |
| 17b: Actuator | 20: Guide unit |
| 30: Cooling unit | 31: Flow detector |
| 32: Cooling water line | 33: Flow control valve |
| 34: Cooling water pump | 36: Cooling water tank |
| 40: Discharge unit | 41: Discharge pipe line |
| 43: Discharge valve | 50: Ejection control unit |

### BEST MODE

Hereinafter, a configuration and an operation of the exemplary embodiment of the present invention will be described in detail with reference to the accompanying drawings. However, it is not intended to limit the present invention to the specific embodiments, and it will be appreciated that the present invention includes all modifications, equivalences, or substitutions included in the spirit and the technical scope of the present invention. In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other specific characteristics, numbers, steps, operations, constituent elements, and components, or a combination thereof in advance. That is, throughout the specification, unless explicitly described to the contrary, the word “comprise” and variations such as “comprises” or “comprising”, will be understood to imply the inclusion of stated elements but not the exclusion of any other elements.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

Here, repeated description and detailed description for known functions and configurations which may unnecessarily obscure the gist of the present invention may be omitted to avoid the ambiguity of the gist of the present invention. Exemplary embodiments of the present invention are provided so that those skilled in the art may more completely understand the present invention. Accordingly, the shape, the size, etc., of elements in the figures may be exaggerated for explicit comprehension.

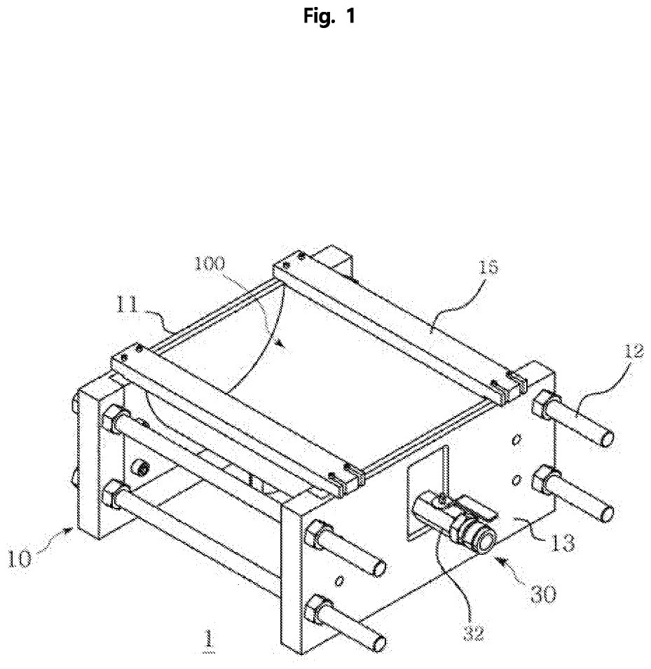

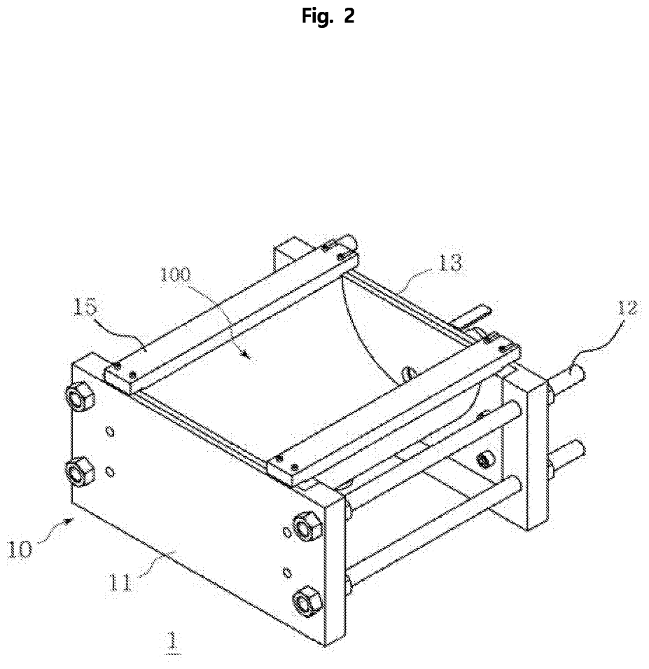

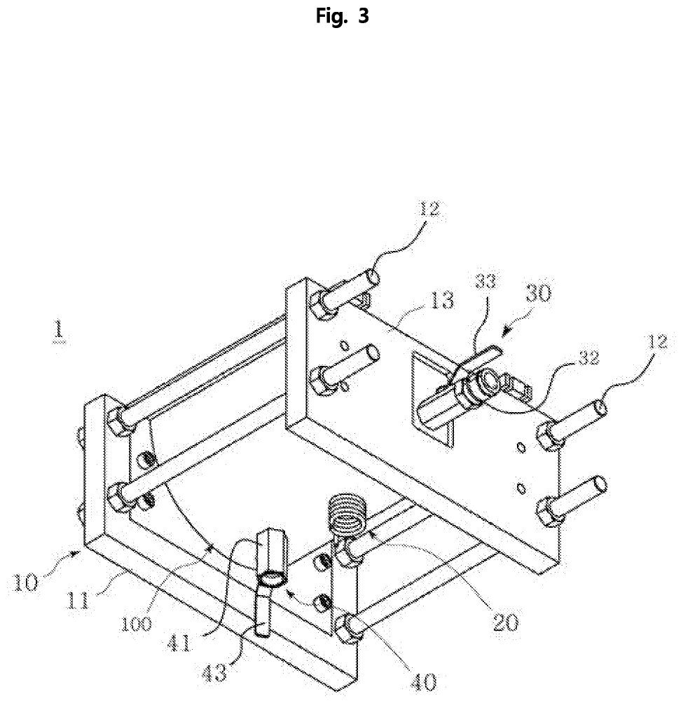

FIGS. 1 to 3 are perspective views of a thermal fatigue crack generator for a large pipe according to the present invention in which a pipe specimen is installed, seen from several directions.

In the drawings, a thermal fatigue crack generator 1 for a large pipe configured by a frame unit 10 which forms a frame and is a holding element to support both sides and an upper surface of a pipe specimen 100 having a semicircular arc cross-section obtained by cutting a cylindrical pipe in a longitudinal direction, a guide unit which is installed to be adjacent to a lower outer surface of the pipe specimen 100 to locally heat the pipe specimen 100, a discharge unit 40 which passes through a lower portion of the pipe specimen 100 to be connected therein in a position without interfering at one side of the guide unit 20 to discharge a cooling water in the pipe specimen 100 to the outside, a cooling unit 30 which is connected to one side of a movable flange 13 configuring the frame unit 10 to inject the cooling water supplied from the outside into the pipe specimen 100, and a cooling water ejection control unit which repeatedly controls operations of the guide unit 20 and the cooling unit 30 to set a thermal fatigue cycle to generate a thermal stress is illustrated.

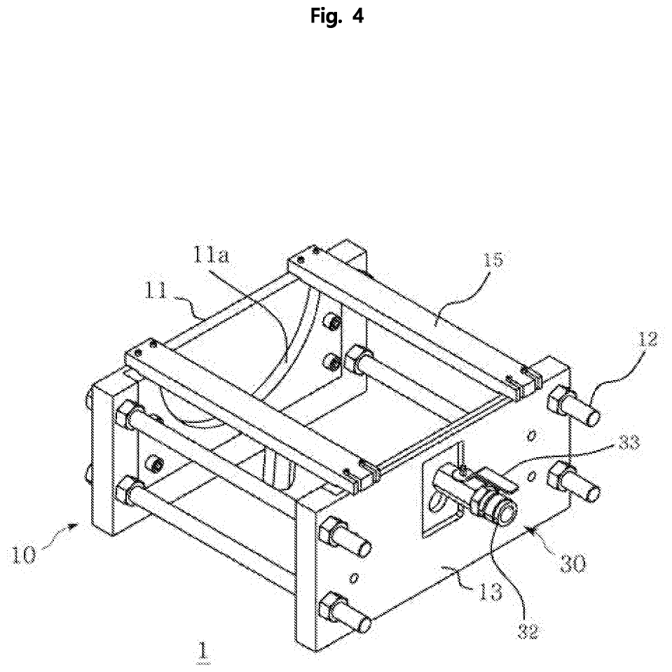

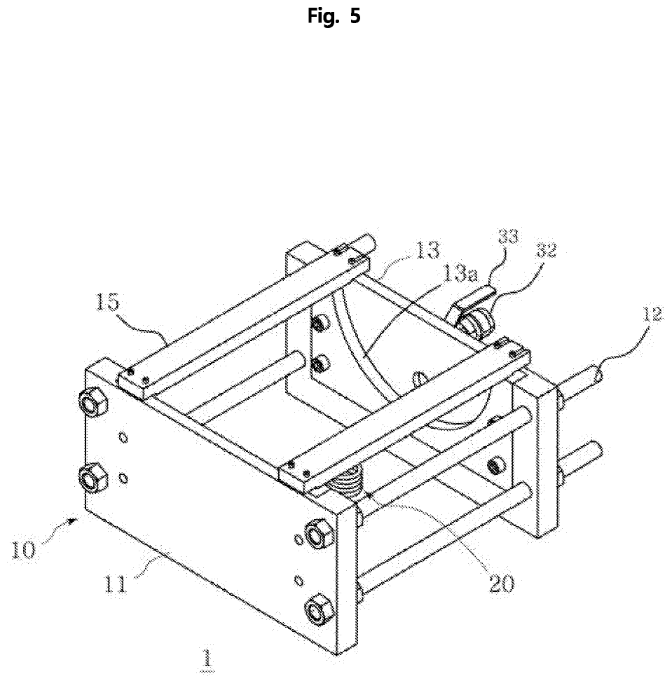

FIGS. 4 and 5 are perspective views for explaining a configuration of a thermal fatigue crack generator for a large pipe according to the present invention in which the pipe specimen 100 is not mounted.

In the drawings, a thermal fatigue crack generator 1 for a large pipe configured by a frame unit 10 which forms a frame and includes a fixed flange 11 and a movable flange 13 disposed to be opposite to each other to be in close contact with both ends of the pipe specimen 100 having a semicircular arc shape to be closed, a plurality of guide posts 12 connecting the fixed flange 11 and the movable flange 13, and an extension/contraction sensing unit 15 which pressurizes and holds an upper edge of the pipe specimen 100, a cooling unit 30 which includes a cooling water line 32 and a flow control valve 33 connected to one side of the movable flange 13 to inject cooling water supplied from the outside into the pipe specimen 100, and a heating unit 20 which locally heats a lower one side of the pipe specimen 100 is illustrated.

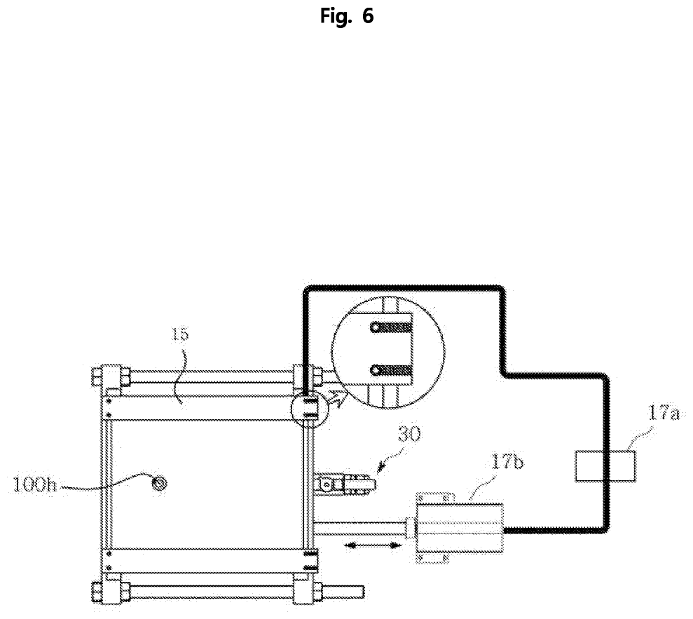

FIG. 6 is a schematic view for explaining a configuration of an extension/contraction sensing unit and a thermal expansion compensating unit in a thermal fatigue crack generator for a large pipe according to the present invention which is a view of a thermal fatigue crack generator for a large pipe of FIG. 1 seen from the top.

In the drawing, the pipe specimen 100 in which both ends and an upper portion are held by the frame unit 10 is illustrated. At this time, in the pipe specimen 100, a cooling water discharge hole 100h is penetrated to be connected to a discharge pipe line 41 which configures a discharge unit 40 to be described below at one side of a lower surface to discharge the cooling water. Further, the movable flange 13 which configures the frame unit 10 is connected to the cooling water line 32 and the flow control valve 33 which configure the cooling unit 30 at one side. Further, the thermal fatigue crack generator 1 for a large pipe in which the extension/contraction sensing unit 15 is in close contact with an upper edge of the pipe specimen 100 not only to serve to hold the upper edge of the pipe specimen, but also to perform a function for sensing extension/contraction of the pipe specimen 100 held between the fixed flange 11 and the movable flange 13 generated in a longitudinal direction due to the repeated cooling and heating operations and the information sensed by the extension/contraction sensing unit 15 adjusts an interval between the fixed flange 11 and the movable flange 13 by a pressurization control unit 17a and an actuator 17b which configure the thermal expansion compensating unit is illustrated.

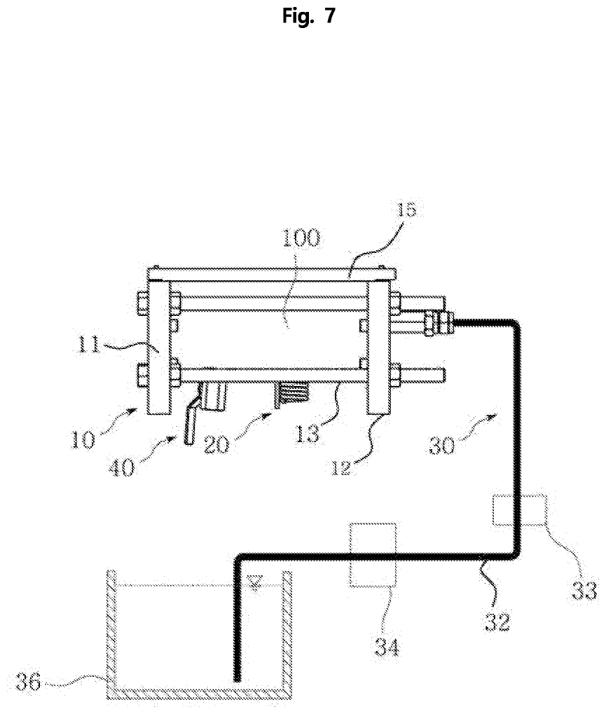

FIG. 7 is a schematic view for explaining a configuration of a cooling unit in a thermal fatigue crack generator for a large pipe according to the present invention.

In the drawing, the pipe specimen 100 having a semicircular arc shape cross-section is held by the frame unit 10 which forms a frame and the heating unit 20 and the discharge unit 40 are disposed at one side of the lower portion of the frame unit 10 so as not to interfere with each other. Further, a cooling water line 32 which configures the cooling unit 30 is connected to one side of the movable flange 13 among the elements which configure the frame unit 10 and the cooling water supplied through the cooling water line 32 is introduced into the pipe specimen 100 through a through hole formed in the movable flange 13. In the meantime, the cooling unit 30 configured by a cooling water tank 36 which preserves cooling water, a flow control valve 33 which is installed on the cooling water line 32 connecting the cooling water tank 36 and the movable flange 13 to control a flow of the cooling water supplied to the pipe specimen 100, and a cooling water pump 34 which supplies the cooling water preserved in the cooling water tank 36 into the pipe specimen is illustrated.

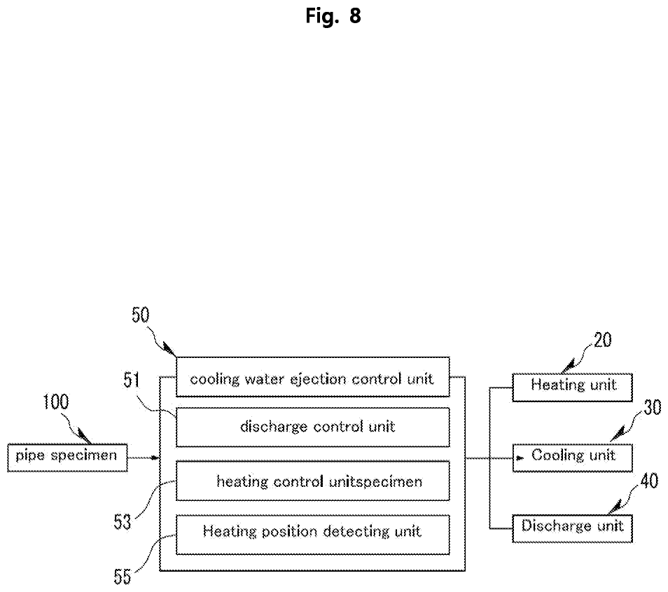

FIG. 8 is a block diagram for explaining a configuration of a cooling water ejection control unit in a thermal fatigue crack generator for a large pipe according to the present invention.

In the drawing, a cooling water ejection control unit 50 which reproduces a thermal fatigue cycle by regularly heating and cooling the pipe specimen 100 by controlling the heating unit 20 and the cooling unit 30 is illustrated. The cooling water ejection control unit 50 includes a discharge control unit 51 which controls a discharging operation for a discharge unit 40 for discharging the cooling water, a heating control unit 53 which controls a heating temperature and an on/off operation of the heating unit 20, and a heating position detecting unit 55 which detects a position of a heating point of the pipe specimen 100 which is locally heated by the heating unit 20.

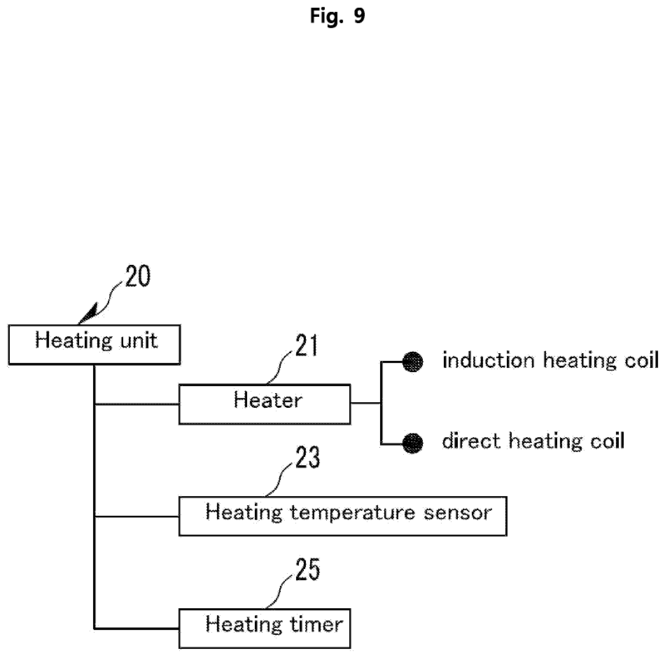

FIG. 9 is a schematic view for explaining a configuration of a guide unit in a thermal fatigue crack generator for a large pipe according to the present invention.

In the drawing, a configuration of a heating unit 20 configured by a heater 21 configured by any one of an induction heating coil or a direct heating coil as an element of heating with a power supplied from the outside, a heating temperature sensor 23 which measures a heating temperature of the heater 21, and a heating timer 25 which measures a heating time of the heater 21 is illustrated.

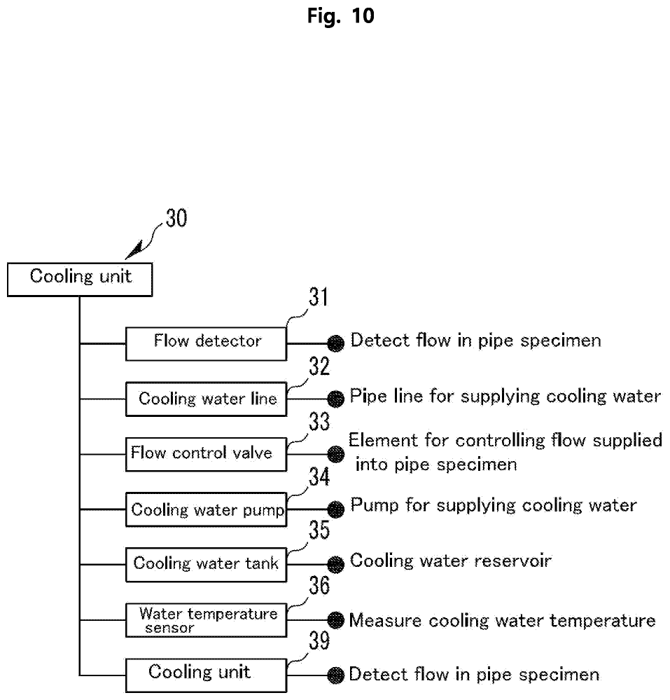

FIG. 10 is a block diagram for explaining a configuration of a cooling unit in a thermal fatigue crack generator for a large pipe according to the present invention.

In the drawing, a cooling unit 30 configured by a flow detector 31 which detects a flow of a cooling water in the pipe specimen 100, a cooling water tank 36 which preserves the cooling water, a cooling water line 32 which supplies the cooling water to the pipe specimen 100, a cooling water pump 34 which is installed on the cooling water line 32 to pump the cooling water preserved in the cooling water tan 36 to forcibly convey the cooling water, a flow control valve 33 which controls the flow of the cooling water supplied to the pipe specimen 100, and a water temperature sensor 39 which measures a temperature of the cooling water supplied to the pipe specimen 100 is illustrated.

The configuration of the thermal fatigue crack generator for a large pipe according to the present invention will be described with reference to the above drawings.

The thermal fatigue crack generator for a large pipe according to the present invention does not control the flow of the cooling water supplied into the pipe specimen 100, but controls the heating unit 20 after completely discharging the cooling water filled in the pipe specimen 100 to the outside through the discharge unit 40 before the heating operation of the heating unit 20 which is installed at one side of the lower portion of the pipe specimen 100 to locally heat to locally heat the test piece 100. As a result, it is possible to precisely control while maximizing the internal temperature variation in a situation in which the shape of the external surface of the pipe specimen 100 does not change. Therefore, the reliability and the effectiveness of the actual crack reference test piece for skill verification of the non-destructive test for the pipe specimen 100 having a diameter of 250 to 610 mm which belongs to a large pipe may be increased.

To this end, the thermal fatigue crack generator for a large pipe according to the present invention is configured by a frame unit 10 which forms a frame, a heating unit 20 which is provided at one side of a lower portion of the pipe specimen 100 held and supported in the frame unit 10 to locally heat the pipe specimen, a cooling unit 3 which is connected to one side of the frame unit 10 to supply the cooling water into the pipe specimen 100, a discharge unit 40 which is connected to a cooling water discharge hole 100h penetrating to one side of the lower portion of the pipe specimen 100 to discharge the cooling water in the pipe specimen 100 to the outside with the received control signal, and a cooling water ejection control unit 50 which controls the operation of the discharge unit 40 to generate the thermal fatigue crack for the pipe specimen 100.

The frame unit 10 is an element for fixing and supporting the pipe specimen 100 having a semicircular arc shape cross-section obtained by cutting a cylindrical pipe having a dimeter of 250 to 610 nm in a longitudinal direction. The frame unit 10 with this configuration is configured by board type fixed flange 11 and movable flange 13 which are disposed to be opposite to each other to be in close contact with both ends of the pipe specimen 100 having a semicircular arc shape to close both ends, a guide post 12 which connects the fixed flange 11 and the movable flange 13 and supports the movable flange 12 to move back and forth with respect to the fixed flange 11, and an extension/contraction sensing unit 15 which pressurizes and supports the upper edge of the pipe specimen 100 to be in contact therewith to prevent the flowing.

Further, the cooling water line 32 which configures the cooling unit 30 is connected to one side of the movable flange 13 and a through hole is formed so as to introduce the cooling water supplied through the cooling water line 32 into the pipe specimen 100.

In the meantime, extension/contraction phenomenon is generated by the heating and the cooling applied to the pipe specimen 100 fixedly supported between the fixed flange 11 and the movable flange 13. The present invention proposes to additionally configure an extension/contraction sensing unit 15 and the thermal expansion compensating unit to maintain an appropriate interval between the fixed flange 11 and the movable flange 13 by sensing a ratio of expansion and contraction of the pipe specimen 100.

The extension/contraction sensing unit 15 not only serves to hold the pipe specimen 100 by being in close contact with the upper edge of the pipe specimen 100 having a semicircular arc shape cross-section to prevent the flowing, but also performs a function of sensing the extension/contraction phenomenon of the pipe specimen 100 held between the fixed flange 11 and the movable flange 13 generated in the longitudinal direction by the repeated heating and cooling operations. The information sensed by the extension/contraction sensing unit 15 is configured to adjust the interval between the fixed flange 11 and the movable flange 13 by a pressurization control unit 17a and an actuator 17b which configure the thermal expansion compensating unit.

For example, when the pipe specimen 100 extends by 5 mm in a longitudinal direction due to a thermal fatigue stress, the extension/contraction sensing unit 15 senses the force or the distance extending in the longitudinal direction to apply a signal to the pressurization control unit 17a which configures the thermal expansion compensating unit. Next, the pressurization control unit 17a applies a control signal to the actuator 17b which pressurizes and supports the movable flange 13 toward the fixed flange 11 based on the sensed information to control the movable flange 13 and the fixed flange 11 to maintain a predetermined interval.

In the meantime, the extension/contraction sensing unit 15 may apply a known elastic displacement sensor which generates an elastic displacement in accordance with the extension/contraction of the pipe specimen 100 and measures the elastic displacement or use a pressurization sensor which is provided in one or both of the fixed flange 11 and the movable flange 13 in a portion in contact with the pipe specimen 100 to measure a pressure in accordance with the extension/contraction of the pipe specimen 100. Various known techniques may be used to sense the extension/contraction of the pipe specimen 100.

The heating unit 20 is an element which is disposed adjacent to a lower outer surface of the pipe specimen to perform a local heating operation. The heating unit 20 is disposed adjacent to one outer surface of the lower portion of the pipe specimen 100 to locally heat and is configured by a heater 21 which is formed by any one of an induction heating coil which is applied with a high frequency current to form a magnetic field to induce the heating or a direct heating coil having a heating line which is supplied with a power to heat, a heating temperature sensor 23 which measures a heating temperature of the heater 21, and a heating timer 25 which measures a heating time of the heater 21. Here, as the heater 21, the high frequency induction heating coil has been proposed, but the present invention is not limited thereto and the direct heating coil which includes a heating line which is supplied with the power to heat may be used.

The cooling unit 30 is an element which forcibly supplies the cooling water into the pipe specimen 100 to cool. The cooling unit forcibly supplies the cooling water into the pipe specimen 100 to cool and is configured by a flow detector 31 which detects a flow of the cooling water in the pipe specimen 100 held by the frame unit 10, a cooling water tank 36 which preserves a predetermined amount of cooling water, a cooling water pump 34 which is installed on the cooling water line 32 for supplying the cooling water to the pipe specimen 100 to pump the cooling water preserved in the cooling water tank 36 to forcibly convey, a flow control valve 33 which controls a flow of the cooling water supplied to the pipe specimen 100, and a water temperature sensor 39 which measures a temperature of the cooling water supplied to the pipe specimen 100.

Referring to the drawing, one end of the cooling water line 32 is connected to one side of the movable flange 13 to be piped to supply the cooling water. At this time, the movable flange 13 is a configuration in which a through hole (no reference numeral) through which the cooling water supplied through the cooling water line 32 is supplied into the pipe specimen 100 located therein is formed.

Further, the flow control valve 33 which is installed on the cooling water line 32 to control the flow of the cooling water supplied to the pipe specimen may include a manual valve which opens/closes a pipe line by means of the manual operation or a solenoid valve which opens/closes the pipe line with a control signal of a cooling water ejection control unit 50 to be described above. However, this may be performed by the known technology so that a detailed description thereof will be omitted.

The discharge unit 40 is an element which is provided at one side of the pipe specimen 100 to discharge the cooling water therein to the outside. The discharge unit 40 is configured by a discharge pipe line 41 whose one end is connected to a cooling water discharge hole 100h penetrating at a lower side of the pipe specimen 100 and a discharge valve 43 which is installed on the discharge pipe line 41 to selectively open/close the pipe line to discharge the cooling water in the pipe specimen 100 to the outside. Here, the cooling water discharge hole 100h preferably penetrates a center portion of the lower surface to naturally discharge the cooling water filled in the pipe specimen 100 and as the discharge valve 43, it is proposed to use a known solenoid valve to be supplied with the control signal of the cooling water ejection control unit 50 to be described below to open/close the pipe line.

The cooling water ejection control unit 50 is an element which applies a control signal to the heating unit 20 and the cooling unit 30 to repeatedly heat and cool the pipe specimen 100 to form a thermal fatigue cycle to generate a local thermal stress. The cooling water ejection control unit senses a heating operation of the heating unit 20 to control the heating unit 20 to perform the heating operation after discharging all the cooling water filled in the pipe specimen 100 by applying a control signal to the discharge unit 40 before the heating operation. The cooling water ejection control unit 50 is mainly configured by a discharge control unit 51, a heating control unit 53, and a heating position detecting unit.

The discharge control unit 51 is an element which applies a control signal for a discharge operation to the discharge unit 40 to eject all the cooling water in the pipe specimen 100 before starting the heating operation of the heating unit 20 in a state in which the cooling water is supplied in the pipe specimen 100.

The heating control unit 53 is an element which is applied with a cooling water discharge completion signal from the discharge control unit 51 to control a heating temperature and an on/off operation of the heating unit 20. That is, the technical feature of the present invention is to control the heating unit 20 to locally heat the pipe specimen 100 in a state in which the cooling water in the pipe specimen 100 is completely discharged and this controls is repeated to maximize the internal temperature variation in a state in which the shape of the external surface of the pipe specimen 100 is not changed. That is, the heating unit 20 is located below the pipe specimen 100 so that the difference between the heating temperature in accordance with a setting temperature and the internal surface temperature of the pipe specimen 100 at the time of cooling by the cooling water ejection control unit 50 which is configured in the pipe specimen 100 may be most significantly and precisely controlled and managed so that the reliability for the thermal stress reproducibility formed by the thermal fatigue cycle which repeats the heating and the cooling may be significantly improved. As a result, the reliability and the effectiveness of the actual crack reference test piece for skill verification of the non-destructive test with respect to a large pipe having a comparative large thickness of a diameter of 250 mm to 610 mm may be ensured.

The heating position detecting unit is an element which detects a position of a heating point of the pipe specimen which is locally heated by the heating unit.

The thermal fatigue crack generator for a large pipe according to the present invention configured as described above regularly and uniformly reproduces the heating and cooling operation with respect to the pipe specimen 100 so that as a result, the reliability for reproducing the thermal fatigue cycle may be increased. Further, when the extension/contraction is generated in the pipe specimen 100 due to the thermal fatigue, the interval between the movable flange 13 and the fixed flange 11 which configure the frame unit 10 is appropriately adjusted by the extension/contraction sensing unit 15 and the pressurization control unit 17a so that the physical damage or deformation of the pipe specimen 100 or the frame unit 10 in accordance with the extension/contraction may be prevented in advance.

In the meantime, according to the present invention, the cooling water filled in the pipe specimen 100 is completely discharged to the outside before performing the heating operation of the heating unit 20 on the pipe specimen 100 and thereafter when the heating unit 20 heats, the cooling water does not remain in the pipe specimen 100 so that the internal temperature variation may be maximized in a situation in which the shape of the external surface of the large pipe does not change.

That is, the heating unit 20 is located below the pipe specimen 100 so that the difference between the heating temperature in accordance with the setting temperature and the internal surface temperature of the pipe specimen 100 by the cooling of the pipe specimen 100 may be most significantly and precisely controlled and managed, so that the reliability for the thermal stress reproducibility formed by the thermal fatigue cycle which repeats the heating and the cooling may be significantly improved. Specifically, the reliability and the effectiveness of the actual crack reference test piece for skill verification of the non-destructive test with respect to a large pipe having a large thickness of a diameter of 250 mm to 610 mm may be ensured.

The present invention is not limited to the exemplary embodiments described herein, and may be employed by changing a part to which the exemplary embodiment is applied, and it would be appreciated by those skilled in the art that various changes and modifications might be made to these embodiments without departing from the spirit and the scope of the invention. Therefore, such changes and modifications may be considered to belong to the claims of the present invention.

1. A thermal fatigue crack generator for a large pipe, comprising:
a frame unit which fixedly supports a pipe specimen having a semicircular shape cross-section obtained by cutting a cylindrical pipe having a diameter of 250 mm to 610 mm in a longitudinal direction;
a heating unit which is disposed adjacent to an outer surface of a lower portion of the pipe specimen to locally heat the pipe specimen;
a cooling unit which includes a cooling water pump which forcibly supplies cooling water into the pipe specimen;
a discharge unit which is provided at one side of the pipe specimen to discharge the cooling water therein to the outside; and
a cooling water ejection control unit which generates a thermal stress formed by a thermal fatigue cycle by repeatedly heating and cooling the pipe specimen by applying a control signal to the heating unit and the cooling unit and senses the presence of the heating operation of the heating unit to control the heating unit to perform a heating operation after discharging the cooling water in the pipe specimen by applying a control signal to the discharge unit before the heating operation.

2. The thermal fatigue crack generator of claim 1, wherein the frame unit includes:
a fixed flange which is in close contact with any one of both surfaces of the pipe specimen in a longitudinal direction to be closed;
a movable flange which is connected to the fixed flange by a plurality of guide posts to slide back and forth and is in close contact with the other surface of the pipe specimen to be closed and is connected with a cooling water supply line through which the cooling water is supplied from the outside at one side;
an extension/contraction sensing unit which senses an extension/contraction rate by the heating and cooling operation acting on the pipe specimen fixedly supported between the fixed flange and the movable flange; and
a thermal expansion compensating unit which is applied with a sensing signal from the extension/contraction sensing unit to displace the fixed flange and the movable flange in a longitudinal direction.

3. The thermal fatigue crack generator of claim 1, wherein the heating unit includes:
a heater which is configured by any one of an induction heating coil which is applied with a high frequency current to form a magnetic field to induce the heating or a direct heating coil having a heating line which is supplied with a power to heat;
a heating temperature sensor which measures a heating temperature of the heater; and
a heating timer which measures a heating time of the heater.

4. The thermal fatigue crack generator of claim 1, wherein the cooling unit includes:
a flow detector which detects a flow of the cooling water in the pipe specimen;
a flow control valve which is installed on a cooling water line supplying the cooling water to the cooling water pump and the pipe specimen to control the flow; and
a water temperature sensor which measures a temperature of the cooling water supplied to the pipe specimen.

5. The thermal fatigue crack generator of claim 1, wherein the discharge unit includes:
a discharge pipe line which is connected into the pipe specimen through a lower side thereof; and
a discharge valve which is installed on the discharge pipe line to selectively open/close a pipe line to discharge the cooling water in the pipe specimen to the outside.

6. The thermal fatigue crack generator of claim 1, wherein the cooling water ejection control unit includes:
a discharge control unit which applies a control signal for a discharge operation to the discharge unit to eject all the cooling water in the pipe specimen before starting the heating operation of the heating unit in a state in which the cooling water is supplied in the pipe specimen;
a heating control unit which is applied with a cooling water discharge completion signal from the discharge control unit to control a heating temperature and an on/off operation of the heating unit; and
a heating position detecting unit which detects a position of the heating point of the pipe specimen which is locally heated by the heating unit.

7. The thermal fatigue crack generator of claim 2, wherein the extension/contraction sensing unit includes any one of an elastic displacement sensor which measures an elastic displacement in accordance with the extension/contraction of the pipe specimen by connecting the fixed flange and the movable flange and a pressurization sensor which is provided in one or both of the fixed flange and the movable flange in a portion in contact with the pipe specimen to measure a pressure; and
the thermal expansion compensating unit includes:
a pressurization control unit which is applied with sensing information from the extension/contraction sensing unit to calculate an extension/contraction rate of the pipe specimen and moves back and forth the movable flange with respect to the fixed flange based thereon to output a control signal to control the contact degree with the pipe specimen; and
an actuator which is applied with a control signal from the pressurization control unit to be connected to any one of the movable flange and the fixed flange to generate a position displacement to a straight direction by a driving source.
